(19) United States
(12) Patent Application Publication
(10) Pub. No.: US 2010/0019012 A1
(43) Pub. Date: Jan. 28, 2010

(54) Blade guard

(76) Inventor: Richard Francis Hurst, Vero Beach, FL (US)

Correspondence Address: Richard M. Saccocio;R.M. Saccocio, P.A., 780 W. Tropical Way, Plantation, FL, 33317, US

(21) Appl. No.: 12/220,772

(22) Filed: Jul. 28, 2008

(51) Int. Cl. B26D 7/22

(52) U.S. Cl. 225/20

(57) ABSTRACT

A blade guard is adapted to be used with a label stripping machine. The blade guard includes a plurality of recesses spaced along a length of an appropriate material. The bottom surface of each recess is angled to coincide with the optimal angle of the cutting blades of the label stripping machine which allows each blade to be precisely oriented for optimal performance of the label stripping machine. When the blades are retracted, the close fit of each recess relative to the blade, serves to clean the blade of any debris that may have been generated during the delabeling operation.

### CROSS REFERENCE TO RELATED APPLICATIONS

This invention is an improvement to my earlier U.S. Pat. No. 5,152,865, issued Oct. 6, 1992, to which it is related.

### BACKGROUND OF THE INVENTION

1. Field of the Invention

This invention relates in general to stripping bottles of adhesively applied labels in such a manner that the label and the adhesive are completely removed as an integral unit from the bottle leaving a “clean bottle” which can then be further processed in accordance with its intended use, and in particular to apparatus and methods to improve the efficiency, operability, and safety of a label stripping machine.

2. Description of the Prior Art

In my prior patent, U.S. Pat. No. 5,152,865 issued on Oct. 6, 1992, entitled “Method for Clean Removing Labels from Containers”, I disclose the very unique method of removing adhesively backed labels from containers such that the label and the adhesive are removed with the adhesive still attached to the label. Thus, a clean bottle surface resulted that could be further used with a new label. Essentially, I invented the method of using an angled blade that comes into contact with the container at the top of the label and moves downward while the bottle is spinning. The label removing process begins with an angled blade contacting a positioned bottle above the top of a label. Simultaneously with the spinning of the bottle, a resiliently mounted blade is caused to move downward so that the blade is relocated at the bottom of the label at the end of the label removing process. As the blade moves downward following the exact contours of the spinning bottle, it incrementally turns the label inside-out. Simultaneously the blade removes the adhesive from the bottle such that the label is removed with the adhesive attached thereto.

At the end of a cycle the label with adhesive attached drops off of the bottle. Needless to say, I have had much success in marketing my invention.

In a commercial embodiment of my aforesaid invention, a plurality of blades are mounted in a horizontally spaced relationship onto a supporting structure that moves vertically causing the plurality of blades to follow the said vertical motion. I had previously discovered that the angle of the cutting edge of the blade relative to the top of the label is critical to the proper operation of my label removing invention.

My prior art label removing methods and apparatus is occasioned with a number of aspects that can be improved.

A primary object of the present invention is to provide apparatus that provides for precise orientation of the angle of each of a plurality of blades associated with my label removing invention.

Another object of the present invention is to provide apparatus that provides safety for a worker from being exposed to the edge of a blade in a retract position as the cutting edge of each blade is retracted into a recess such that the cutting edge of the blades are not exposed.

Another object of the present invention is to provide a label stripping machine with means to keep the blades free from debris occasioned with the label removing process.

The above-stated objects as well as other objects which, although not specifically stated, but are intended to be included within the scope of the present invention, are accomplished by the present invention and will become apparent from the hereinafter set forth Detailed Description of the Invention, Drawings, and the Claims appended herewith.

### SUMMARY OF THE INVENTION

The present invention accomplishes the above-stated objectives as well as others, as may be determined by a fair reading and interpretation of the entire specification herein, which comprises in triune combination a blade guard, a guide to establish a correct label removing angle of a plurality of blades, and a blade cleaner. The combination apparatus is removably attached to a plurality of blade support members that retract, move forward, and travels vertically during the label removing process. An embodiment of the blade guard includes a plurality of inclined surfaces extending along the depth of the blade guard, each of the inclined surfaces are separated by a spacing block. When the stripping machine is set up to strip the labels from a particular sized bottle, i.e. the blades are correctly positioned and angled by use of the blade guard, the operation begins by the plurality of the blades moving forward with each precisely contacting a respective bottle. After the label stripping operation is complete, the blades retract to a position within the blade guard and in so doing the blades are cleaned of debris resulting from the label stripping. In the retracted position, all of the cutting edges of the blades are preferably positioned within the blade guard.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a frontal view of my prior art invention;

FIG. 2 is a side view of one label stripper of my prior art invention; and,

FIG. 3 is an isometric view of the combination blade guard.

### DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

Reference is now made to the drawings, wherein like characteristics and features of the present invention shown in the various figures are designated by the same reference numerals.

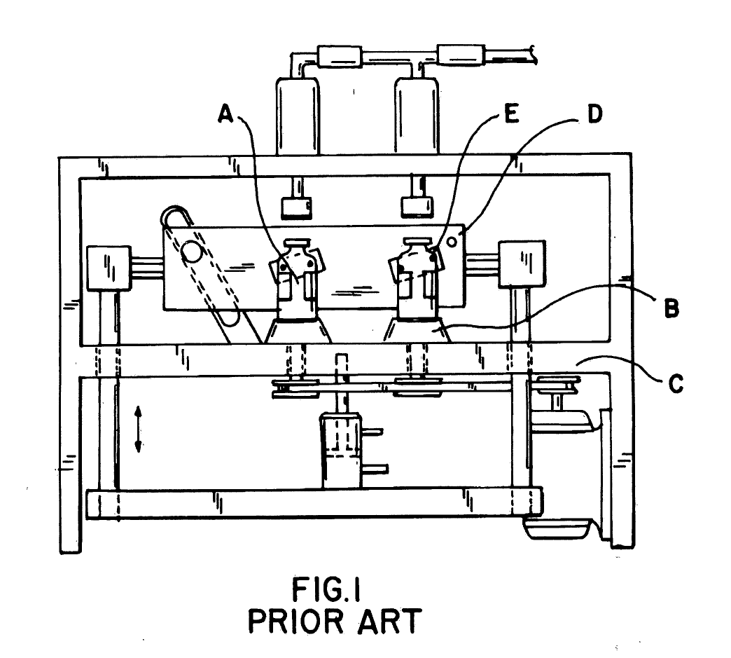

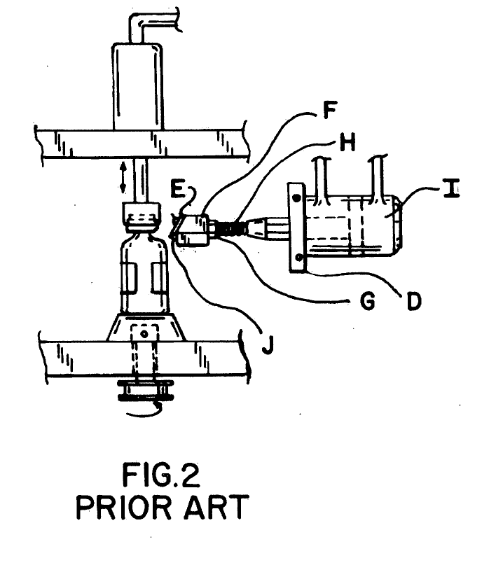

Reference is now made in particular to FIGS. 1, and 2, of the drawings which illustrate my prior invention. A brief description of the operation of the same will provide a better understanding of the preset invention. As seen, the label stripping operation involves simultaneously stripping labels from a plurality of bottles such that the machine is labor and cost effective. The bottles A are placed on a rotating member B positioned on a horizontal support bar C. A plate D behind the bottles provides for blade support, blade retraction, blade forward motion, blade vertical motion and blade horizontal motion necessary to remove the labels. FIG. 2 of the prior art serves to clarify the manner in which the blade E is able to approach the bottle in preparation to remove the label and adhesive. FIG. 2 shows the blade extends slightly outward and downward from the block F to which the blade is attached. In my prior invention the procedure for setting the exact horizontal angle of the blades was accomplished manually for each of the plurality of the blade. The vertical alignment was solved by precisely machining the angled front face of the support block F and since the blade is firmly connected up against the front face of the support block F, the vertical alignment was properly achieved. However, the manual setting of the horizontal angle of the blades, was entirely dependent upon the operator of the machine. This sometimes resulted in one or two of the blades being set at a slightly improper angle which necessarily affected the optimal efficiency of the machine to fully remove the labels and adhesive of the complete plurality of the bottles. A further inconvenience with my prior art method and apparatus comprised the debris generated by the label stripping operation. Mostly, the labels simply fell on to the horizontal support plate C, but sometimes centrifugal force would throw the label or part of it in various directions including the surface of a blade and the blade support member. Accordingly, clean up was sometime necessary

Referring again to FIG. 1 it is seen that the blades are at a slight defined angle to the horizontal, and at the beginning of the label removal process the longitudinal center of each blade is positioned at the top edge of the labels. Then, as the blades moves vertically downward and the bottles begin to turn on their vertical axis, the blades begin to peel off the label by turning it backward on itself. As the blades move further downward, the label is incrementally turned inside-out. Simultaneously the blades squeegee adhesive from the bottle such that it adheres to the detaching label. At the end of a cycle the entire label is removed in one piece with the adhesive still attached to the label. Thus a clean bottle free of a label and adhesive is accomplished.

The present invention utilizes the structure and operation of my prior art invention, but in a manner that facilitates its precision and efficiency, safety, and ease of operation. It can be well envisioned that a critical step in the operation of my prior art invention is the correct angle of each of the plurality of blades. Without this critical step being substantially perfectly performed, one or more of the labels and adhesive may not be completely removed, and additional debris can be created. Because of the attached glue, the debris can stick to various parts of the machine. If the debris is at or on a part of the machine that is affected by the presence of the debris, the machine must be shut down and the debris manually removed. Also in my prior art it is seen that the cutting edge of the blade F is located slightly above the bottom of the blade support block F and protrudes slightly outward. This orientation creates a small crevice J that facilitates the downward turning of the label as it is being removed from the bottle.

The ability of the present blade guard to allow complete retraction of the blades into the blade guard facilitates the clean up in safety.

The approximate correct horizontal angle of the blades is seen in FIG. 1. It is to be noted that the same blade angle is an important requirement in order for all of the blades to properly remove their respective label and generate a minimal amount of sticky debris. The present invent provides for the exact positioning and alignment of each blade in addition to other advantageous features.

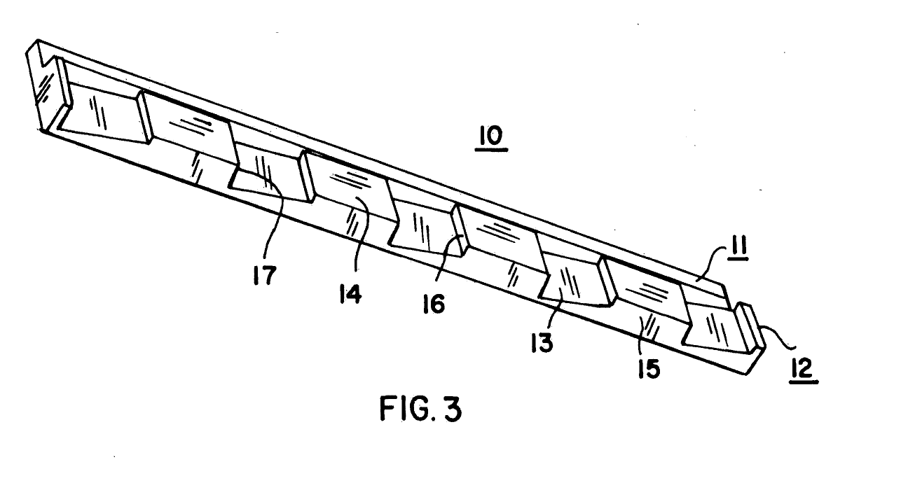

The inventive apparatus 10 is shown in FIG. 3. It comprises a blade guard 10 comprising an elongated strip of an appropriate material such as plastic or aluminum; however, a non stick material such as Teflon is preferred. Referring again to FIG. 2, it is seen that blade E is mounted to block F which in turn is attached to a threaded but non rotating shaft H of an air cylinder I. Air cylinder I imparts the motion of the blades E in moving forward and moving backward (retraction of the blades).

The blade guard 10 is preferably mounted to the prior art vertical plate D in such a manner that the front surface 15 of the blade guard extends forward of the blade cutting edges when the blades are in the retracted position. The manner in which the blade guard is attached is not material provided that it allows the blades and the blade support blocks or members to be substantially enclosed between the openings between the spacer blocks 14. For example, a horizontal plate (not shown) can be attached along the length of the bottom edge of the vertical plate D and extend forward toward the blade block F. Of course, the blade guard is to be horizontally positioned such that the angled surfaces 12 are aligned with the blades E and in line with the forward and aft motion of the blades E. The connection can comprise machine screws threaded into the horizontal plate (not shown).

As shown, the blade guard 10 can comprise an elongated member having a back portion 1 and a front portion 12. The back portion can include drilled holes that allow the afore mentioned machine screws to be threaded into the horizontal blade guard support plate (not shown). The front portion 12 of the blade guard 10 includes a plurality of angled surfaces 13 separated by substantially rectangular spacer portions or members 14. Each of the angled surfaces is configured to provide the precise horizontal angle of the blades that has been proven to optimize the label removal process, i.e. between 5 to 10 degrees. It is preferred that the depth (front to back dimension) of the angled surfaces 13 is such that it is slightly greater than the combined depth of the blades E and the blade support blocks F. Such depth allows the blade blocks F and the blades E to be within the confines of the angled surfaces 13 when the blades are in the fully retracted position. In other words, the cutting edges of the blades E are not exposed when the blades E are in the fully retracted position. In an alternate embodiment, the blade guard 10 can be positioned such that the cutting edge of the blades protrude slightly from the front edge of the blade guard.

Inasmuch as the individual blades and attached blade supporting blocks can move forward to expose the cutting edges of the blades to the labels, and can be retracted to a position within the blade guard when the blades are retracted after each label removing procedure, the bottoms of the blade blocks are caused to slide against the angled surface 13 while the sides of the blade blocks are caused to slide against the sides 16 and 17 of the spacers 14. This action substantially cleans the sliding surfaces of debris from the removed labels after each label removal operation. If the debris does not simply fall away, it is a simple and safe procedure for the worker to manually remove it. In the same manner if any debris sticks to the front of the blades E, the worker can safely and manually remove it when the blades are in the retracted position by for example, a tweezers, forceps or similar tool. There is also the possibility that some debris and attached adhesive can accumulate in the crevices J. This debris and adhesive can also be removed by an appropriate tool similar to a dental pick. Cleaning of the crevices J can be more easily accomplished if the cutting edges slightly protrude from the angled surfaces. This extremely useful advantage substantially reduces any down time needed for debris removal.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breadth and scope of the claims here appended.

1. A blade guard adapted to be attached to a label stripping machine wherein said label stripping machine includes a plurality of angled cutting blades, each being attached to a support block, said blades and said support blocks being capable of being moved forward and aft, said blade guard comprising
an elongated member consisting of a plurality of angled surfaces having a front to back depth, and a side to side width, said angled surfaces being spaced along the length of said blade guard,
each of said angled surfaces being spaced from each other by a spacer portion of said blade guard,
said spacer portions having a top surface that extends above said angled surface.

2. The blade guard of claim 1, wherein said blade guard is made from a non stick material taken from the group comprising Teflon, high density polyethylene, Delrin and nylon.

3. The blade guard of claim 1, wherein the combination of said angled surfaces and said spacer portions form a recess within said blade guard at every location of said angled surfaces.

4. The blade guard of claim 3 wherein each recess is configured to fit therein a cutting blade and the blade support block when said cutting blade is in the aft position.

5. The blade guard of claim 3 wherein said angle of said cutting blade is adjusted to the angle of said angled surface.

6. The blade guard of claim 3 wherein a close fit exists between the support block and attached cutting blade and the recess associated therewith.
